(19) United States
(12) Patent Application Publication
(10) Pub. No.: US 2023/0237970 A1
(43) Pub. Date: Jul. 27, 2023

(54) DISPLAY DEVICE FOR REDUCING MOTION BLUR AND CONTROL METHOD THEREOF

(71) Applicant: QISDA CORPORATION, Taoyuan City (TW)

(72) Inventors: Tse-Wei Fan, Taoyuan City (TW); Wei-Yu Chen, New Taipei City (TW)

(73) Assignee: QISDA CORPORATION, Taoyuan City (TW)

(21) Appl. No.: 17/730,162

(22) Filed: Apr. 26, 2022

(30) Foreign Application Priority Data
Jan. 27, 2022 (CN) 202210102253.4

(51) Int. Cl. G09G 3/34

(52) U.S. Cl. CPC G09G 3/342; G09G 2320/0266; G09G 2320/0626

(57) ABSTRACT

A method of controlling a display device includes obtaining a duty cycle of a backlight control signal, and adjusting a starting time of a pulse in the backlight control signal at least according to the duty cycle. The backlight control signal is used to control a backlight of the display device.

### CROSS REFERENCE TO RELATED APPLICATION

This non-provisional application claims priority of China patent application No. 202210102253.4, filed on 27^{th} Jan., 2022, included herein by reference in its entirety.

### BACKGROUND OF THE INVENTION

### 1. Field of the Invention

The invention relates to a display method, and in particular, to a display device for reducing motion blur and a control method thereof.

### 2. Description of the Prior Art

A liquid crystal display (LCD) is a flat display device that uses a backlight to display images. In the LCD, liquid crystals require a finite amount of time to perform phase transitions. If the backlight is turned on continuously, and one or more moving objects are present in consecutive images, the user will see the process of phase transitions of the liquid crystals, resulting in image artifact or motion blur, and degrading user experience while viewing a video. Therefore, how to reduce the motion blur in images on the display device remains a challenging issue in the related display field.

### SUMMARY OF THE INVENTION

According to an embodiment of the invention, a control method for use in a display device includes obtaining a duty cycle of a backlight control signal of controlling a backlight source of the display device, and adjusting a starting time of a pulse in the backlight control signal according to at least the duty cycle.

According to another embodiment of the invention, a display device includes a backlight source and a controller. The controller is coupled to the backlight source, and is used to obtain a duty cycle of a backlight control signal, and adjust a starting time of a pulse in the backlight control signal according to at least the duty cycle. The backlight control signal is used to control the backlight source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a display system according to an embodiment of the invention.

FIG. 2 is a schematic diagram of the screen displayed on the display panel in FIG. 1.

FIG. 3 is a schematic diagram of overlapping video frames owing to slow phase transitions of liquid crystals.

FIG. 4 is a flowchart of a method of controlling the display device in FIG. 1.

FIG. 5 is a flowchart of Step S404 in FIG. 4.

FIG. 6 shows signal waveforms of the display device in FIG. 1 having 10% duty cycle.

FIG. 7 shows signal waveforms of the display device in FIG. 1 having 22% duty cycle.

FIG. 8 shows signal waveforms of the display device in FIG. 1 having 49% duty cycle.

### DETAILED DESCRIPTION

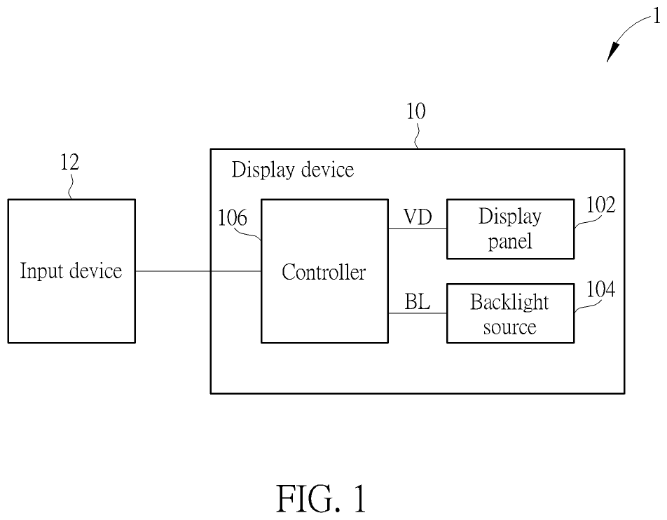

FIG. 1 is a block diagram of a display system 1 according to an embodiment of the invention. A display device 10 in the display system 1 may automatically compute the time to turn on the backlight for various backlight duty cycles, so as to obtain an optimal period of turning on the backlight, such as the middle portion of the screen for sharpening a preset area of the screen, reducing motion blur under various backlight duty cycles, achieving automation and brightness adjustment, and enhancing product functionality without increasing manufacturing costs.

The display system 1 includes a display device 10 and an input device 12. The display device 10 includes a display panel 102, a backlight source 104 and a controller 106. The display panel 102 may be disposed on the backlight source 104. In some embodiments, other optical elements such as a light guide plate, a diffuser, a brightness enhancement film, and a polarizer may be disposed between the display panel 102 and the backlight source 104. The controller 106 may be coupled to the input device 12, the display panel 102 and the backlight source 104.

The controller 106 may be a microcontroller or other control circuits. The controller 106 may receive a frame signal and a synchronization signal from a display card or other video sources, and transmit a video frame signal VD to the display panel 102 and a backlight control signal BL to the backlight source 104. The synchronization signal may be a vertical synchronization signal. The display panel 102 may update the screen from top to bottom and row by row according to the video frame signal VD, and the backlight source 104 may be controlled by the backlight control signal BL to emit light and illuminate the display panel 102 to display the image on the display panel 102. The luminance of the backlight source 104 may be controlled by pulse width modulation, that is, controlled by the duty cycle of the backlight control signal BL. The user may enter or alter the duty cycle of the backlight control signal BL via the input device 12. The input device 12 may be implemented by a combination of software, firmware and hardware, and may be integrated into the display device 10 or may operate separately from the display device 10. In some embodiments, the input device 12 may be a touch screen, a keyboard, a mouse, a key or other input devices. The user may use the input device 12 to select a level of backlight or adjust the backlight control slider to adjust the duty cycle of the backlight control signal BL. The duty cycle of the backlight control signal BL may be stored in an internal memory or an external memory of the controller 106. The controller 106 may obtain the duty cycle of the backlight control signal BL from the internal memory or the external memory thereof, and adjust a starting time of the pulse of the backlight control signal BL according to at least the duty cycle, so as to reduce the motion blur.

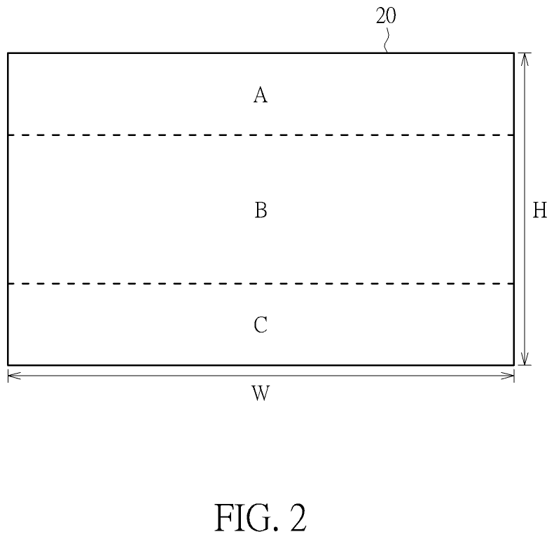

FIG. 2 is a schematic diagram of the screen 20 displayed on the display panel 102. The screen 20 may have a dimension of W×H, where W is the screen width, H is the screen height, and the screen width W and the screen height H may be expressed in pixels, for example, 1920×1080 indicates that the screen width W is 1920 pixels and the screen height H is 1080 pixels.. The screen 20 may be divided into portions A to C, respectively located at the top, middle and bottom of the screen 20. The portion A may be located from the first row to ¼ of the screen 20, portion B may be located from ¼ to ¾ of the screen 20, and portion C may be located from ¾ to the last row of the screen 20. The video frame signal VD may include data frame of the screen 20, and include the data of portions A to C in sequence.

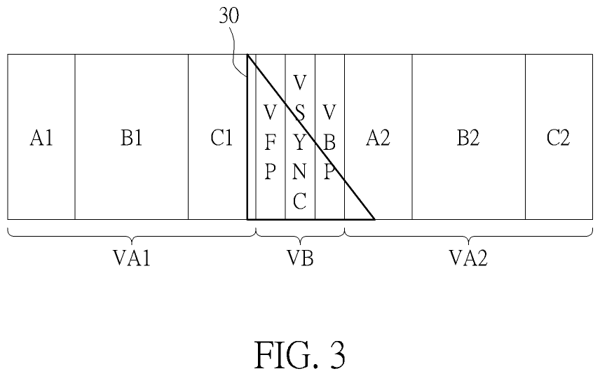

The display panel 102 may be a liquid crystal panel with a relatively slow transition of liquid crystals, such as an in-plane-switching panel or a vertical alignment panel. Since the phase transitions of the liquid crystals of the display panel 102 are relatively slow, all the liquid crystals may be rotating when the screen 20 is updated, and the data of portion C of the previous screen 20 may be overlapping with the current screen 20 due to the phase transitions of the overdriven liquid crystals, resulting in motion blurs in the portion C of the previous picture 20 and the portion A of the current picture 20. For example, it may take 2 milliseconds (ms) to overdrive the liquid crystals to perform phase transitions, the number of rows in the entire area of the display device 10 may be 1215, the update rate may be 240 Hz, and the length of the overdriven liquid crystal transition may be 583 rows (=0.002/(240*1215)⁻¹), and consequently, the last row of the portion C of the previous screen 20 will be overlapping with the portion A of the current screen 20. FIG. 3 is a schematic diagram of overlapping video frames owing to slow phase transitions of liquid crystals, including frame data A1 to C1, a vertical front porch (VFP) interval, a vertical synchronization (VSYNC) interval, and a vertical back porch (VBP) interval, and frame data A2 to C2 arranged in sequence. The frame data A1 to C1 may be referred to as an active video frame VA1, and may correspond to the upper, middle and lower portions of the screen 20, respectively. The VFP interval, the VSYNC interval, and the VBP interval may be referred to as a blanking interval VB. The frame data A2 to C2 may be referred to as an effective image frame VA2, and may correspond to the upper, middle and lower portions of the screen 20, respectively. The active video frames VA1 and VA2 may be used to generate two consecutive frames, respectively. The bald triangle 30 shows that the frame data C1 of the active video frame VA1 will be overlapping with VFP, VSYNC, VBP and the frame data A2 of the active video frame VA2, generating motion blurs in the portion C and the portion A of the screen 20 corresponding to the frame data C1 and A2. In some embodiments, the portion C corresponding to the frame data C1 is blurrier than the portion A corresponding to the frame data A1. The display device 10 will not light up the backlight source 104 in the portion C and/or the portion A where the motion blur occurs, thereby reducing image artifacts and enhancing sharpness of the motion picture. Since the screen portion right after turning on the backlight source 104 will show the sharpest image, the controller 106 may adjust the starting time of the pulse of the backlight control signal BL to reduce or remove the motion blur in the portions A and C, turning on the backlight source 104 during the display panel 102 updating the upper middle portion of the screen 20, e.g., during the display panel 102 updating the frame data B1 and B2, thereby configuring the portion B of the screen 20 to be sharpest. In some embodiments, the starting time of the pulse of the backlight control signal BL may fall in the period of the display panel 102 updating the upper half of the screen, and a portion of the ON time of the pulse of the backlight control signal BL may fall at least in the period of the display panel 102 updating ¼ to ½ of the screen, resulting in the sharpest portion B. In some embodiments, the starting time and the ON time of the pulse of the backlight control signal BL may fall in the period of the display panel 102 updating ¼ to ½ of the screen, resulting in the sharpest portion B, while ensuring that the level of blurriness of the portions A and C are similar.

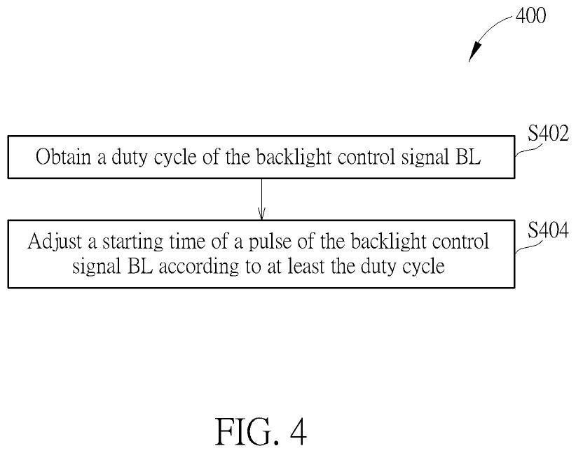

FIG. 4 is a flowchart of a method 400 of controlling the display device 10. The method 400 includes Steps S402 and S404 to enable the controller 106 to adjust the starting time of the pulse of the backlight control signal BL. Any reasonable step change or adjustment is within the scope of the disclosure. Steps S402 and S404 are detailed as follows:

Step S402: Obtain a duty cycle of the backlight control signal BL;

Step S404: Adjust a starting time of a pulse of the backlight control signal BL according to at least the duty cycle.

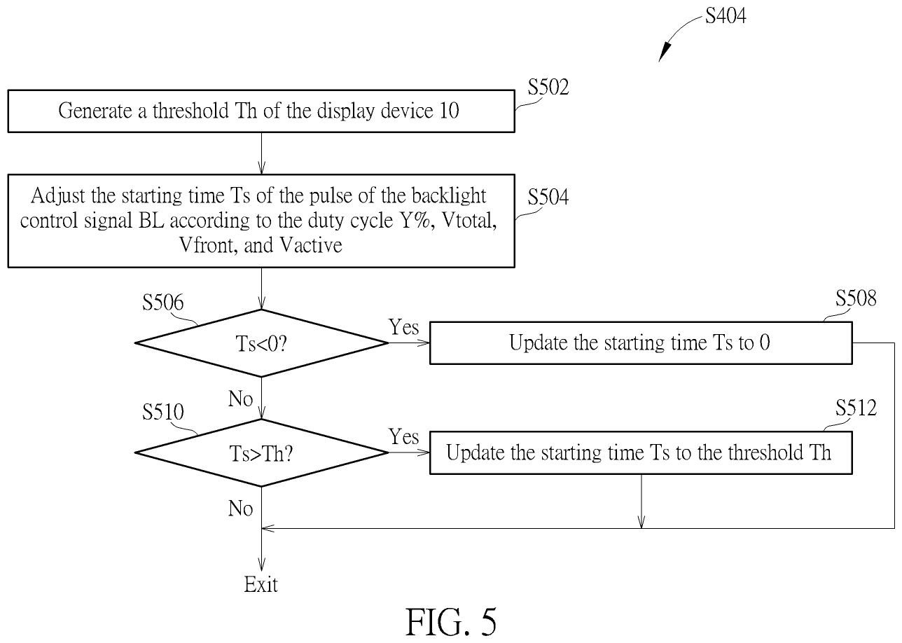

In Step 404, when the duty cycle increases, the controller 106 may bring forward the starting time of the pulse of the backlight control signal BL, and when the duty cycle decreases, the controller 106 may postpone the starting time of the pulse of the backlight control signal BL. For example, if the duty cycle is 25% and the number of rows in the entire area is 1215, the starting time of the pulse of the backlight control signal BL may fall in the period of the display device 10 updating 24.2% of the number of rows in the entire area, and the backlight source 104 may be turned on when the display panel 102 updates the 294th row (=1215*0.242). If the duty cycle is 30%, the starting time of the pulse of the backlight control signal BL may fall in the period of the display device 10 updating 19.2% of the number of rows in the entire area, and the backlight source 104 may be turned on when the display panel 102 updates the 233rd row (=1215*0.192). If the duty cycle is 22%, the starting time of the pulse of the backlight control signal BL may fall in the period of the display device 10 updating 27% of the number of rows in the entire area, and the backlight source 104 may be turned on when the display panel 102 updates the 328th row (=1215*0.27). Therefore, when the duty cycle is increased from 25% to 30%, the starting time of the pulse of the backlight control signal BL may be brought forward from the 294th row to the 233rd row; and when the duty cycle is reduced from 25% to 22%, the starting time of the pulse of the backlight control signal BL may be postponed from the 294th row to the 328th row. In some embodiments, the controller 106 may adjust the starting time of the pulse of the backlight control signal BL according to the duty cycle, the number of rows in the entire area of the display device 10, the number of rows in the vertical front porch of the display device 10, and the number of rows in the active area of the display device 10, and the actual implementation thereof may be shown in FIG. 5.

FIG. 5 is a flowchart of Step S404 in the control method 400, including Steps S502 to S514 for generating the starting time of the pulse of the backlight control signal BL. Any reasonable step change or adjustment is within the scope of the disclosure. Steps S502 to S514 are detailed as follows:

Step S502: Generate a threshold Th of the display device 10;

Step S504: Adjust the starting time Ts of the pulse of the backlight control signal BL according to the duty cycle Y %, Vtotal, Vfront, and Vactive;

Step S506: Determine whether the starting time Ts is less than 0? if so, proceed to Step S508; if not, go to Step S510;

Step S508: Update the starting time Ts to 0; exit Step S404.

Step S510: Determine whether the starting time Ts is greater than the threshold Th? If so, go to Step S512; if not, exit Step S404.

Step S512: Update the starting time Ts to the threshold Th; exit Step S404.

In Step 502, the controller 106 generates the threshold Th of the display device 10 according to Equation (1) as follows:

Th=((Vactive/4+Vfront)/(Vtotal/100)) Equation (1)

where Th is the threshold;
Vactive is the number of rows in the active area of the display device 10;
Vfront is the number of rows in the vertical front porch of the display device 10; and
Vtotal is the number of rows in the entire area of the display device 10.

For example, the number of rows Vactive in the active area may be 1080, the number of rows in the vertical front porch Vfront may be 57, the number of rows in the entire area may be 1215, and the threshold Th may be approximately 27% (=1080/4+57)/(1215/100)).

In Step 504, the controller 106 generates the threshold Th of the display device 10 according to Equation (2) as follows:

Ts=Th−((Y%*Vtotal−(Vactive/4))/(Vtotal/100)) Equation (2)

Wherein Ts is the starting time of the pulse of the backlight control signal BL;
Th is the threshold;
Y % is the duty cycle;
Vtotal is the quantity of rows in the entire area of the display device 10; and
Vactive is the number of rows in the active area of the display device.

For example, the threshold Th may be 27%, the duty cycle may be 25%, the number of rows in the active area Vactive may be 1080, the number of rows in the vertical front porch may be 57, and the number of rows in the entire area may be 1215, and the starting time Ts of the pulse of the backlight control signal BL may be 24.2%(=2740.25*1215-1080/4)/(1215/100))). Table 1 shows the duty cycles Y % and the starting times Ts of the pulse of the backlight control signal BL computed according to Equation (2). The starting time Ts is expressed in percentage of the number of rows in the entire area. For example, when the duty cycle Y % is 25%, the starting time Ts is the 294th row (=1215*0.242) in the entire area.

TABLE 1

| | | | Updated |
|---|---|---|---|
| Y(%) | Th(%) | Ts(%) | Ts(%) |
| 65 | 27 | −10.8 | 0 |
| 56 | 27 | −6.8 | 0 |
| 49 | 27 | 0 | 0 |
| 40 | 27 | 9.2 | 9.2 |
| 30 | 27 | 19.2 | 19.2 |
| 25 | 27 | 24.2 | 24.2 |
| 22 | 27 | 27.2 | 27 |
| 10 | 27 | 39.2 | 27 |
| 5 | 27 | 44.2 | 27 |

In Step 506, if the starting time Ts is less than 0, the pulse of the backlight control signal BL starts from the previous screen 20. Since the earliest time the pulse of the backlight control signal BL may start is the beginning of the current screen 20, if the starting time Ts is less than 0, the controller 106 updates the starting time Ts to 0 (Step 508) to set the pulse of the backlight control signal BL to start from the first row of the entire area, and Step S404 is exited. For example, in Table 1, when the duty cycle Y % is 56%, the starting time Ts is less than 0 (−6.8<0), and thus, the controller 106 updates the starting time Ts to 0. If the starting time Ts is greater than 0, the pulse of the backlight control signal BL will not start until the starting time Ts is reached.

In Step 510, if the starting time Ts is greater than the threshold Th, the pulse of the backlight control signal BL will start after ¼ of the screen 20. However, since the preferred starting time of the pulse of the backlight control signal BL falls in ¼ of the screen 20, the controller 106 updates the starting time Ts to the threshold Th (Step 512), so that the pulse of the backlight control signal BL starts from the position of ¼ of the screen 20. For example, in Table 1, when the duty cycle If the ratio Y % is 10%, the starting time Ts is greater than the threshold Th (39.2<27), and the controller 106 updates the starting time Ts to 27%. And Step S404 is exited. If the starting time Ts is less than the threshold Th, the optimal starting time of the pulse of the backlight control signal BL falls in the period of the display panel 102 updating ¼ of the screen 20, and Step S404 is exited. For example, in Table 1, when the duty cycle Y % is 25%, the starting time Ts is less than the threshold Th (24.2<27), and thus, the starting time Ts is maintained at 24.2%.

In some embodiments, Steps S506 and S508 and Steps S510 and S512 may also be swapped in place, so that the comparison between the starting time Ts and the threshold Th is performed first, and then the comparison between the starting time Ts and 0 is performed.

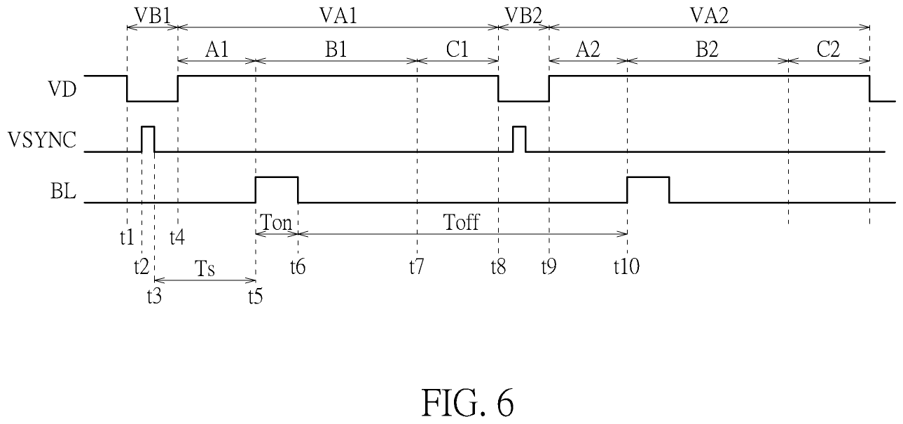

FIG. 6 shows signal waveforms of the display device 10 having 10% duty cycle. FIG. 6 sequentially includes a blanking interval VB1, an active video frame VA1, a blanking interval VB2 and an active video frame VA2. The active video frame VA1 sequentially includes frame data A1 to C1, and the active video frame VA2 sequentially includes frame data A2 to C2. According to Table 1, when the duty cycle Y % is 10%, the updated starting time Ts is 27%.

At Time t1, the video frame signal VD is disabled, and the blanking interval VB1 begins. Between Times t2 and t3, the controller 106 receives the synchronization signal VSYNC. The interval between Times t1 and t2 is referred to as the VFP interval. The starting time Ts is measured from the end of the pulse in the synchronization signal VSYNC (t3). At Time t4, the video frame signal VD is enabled, and the active video frame VA1 starts. The interval between Times t3 and t4 is referred to as the VBP interval. At Time t5, the display panel 102 has updated to 27% of the number of rows in the entire area, and the pulse of the backlight control signal BL starts. At Time t6, the display panel 102 has updated to 37% of the number of rows in the entire area, and the pulse of the backlight control signal BL ends. The interval between Time t5 and Time t6 is referred to as the ON time Ton of the pulse of the backlight control signal BL. At Time t7, the frame data B1 ends. At Time t8, the active video frame VA1 ends. At Time t9, the active video frame VA2 starts, and at Time t10, the pulse of the backlight control signal BL starts again. The interval between Time t6 and Time t10 is referred to as the OFF time Toff of the pulse of the backlight control signal BL.

Since the pulse of the backlight control signal BL starts at ¼ of the screen 20 and ends before ½ of the screen 20, the level of blurriness of the portions A and C of the screen 20 are similar and the image in the portion B is sharper, thereby reducing the motion blur.

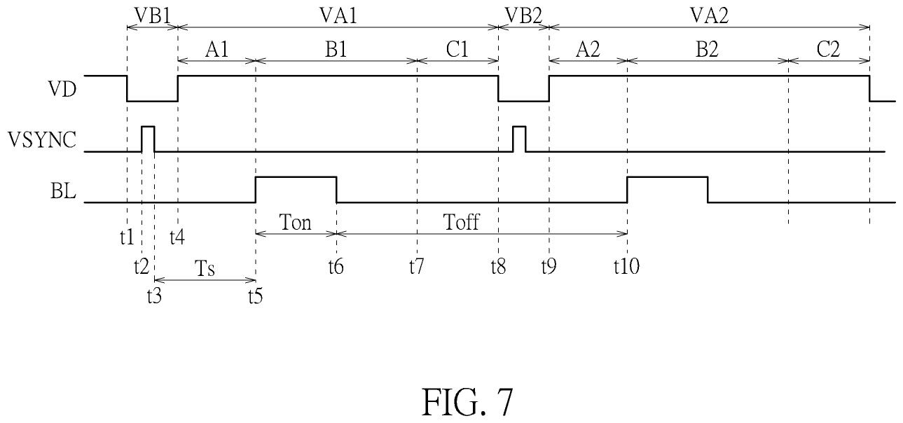

FIG. 7 shows signal waveforms of the display device 10 having 22% duty cycle. According to Table 1, when the duty cycle Y % is 22%, the updated starting time Ts is 27%. The operations of the display device 10 at Times t1 to t5 and Times t7 to t10 in FIG. 7 are similar to those at Times t1 to t5 and Times t7 to t10 in FIG. 6, and details therefor are not repeated here for brevity. At Time t6, the display panel 102 has updated to 49% of the number of rows in the entire area, and the pulse of the backlight control signal BL ends. Since the pulse of the backlight control signal BL starts at ¼ of the screen and ends at ½ of the screen, the level of blurriness of the portions A and C of the screen 20 are similar and the image in the portion B is sharper, thereby reducing the motion blur.

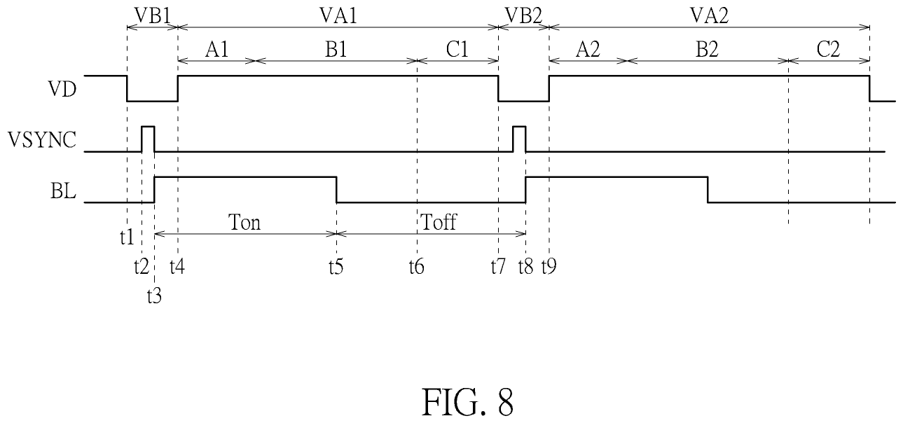

FIG. 8 shows signal waveforms of the display device 10 having 49% duty cycle. According to Table 1, when the duty cycle Y % is 49%, the updated starting time Ts is 0%. The operations of the display device 10 at Times t1 to t2 and Times t6 to t9 in FIG. 8 are similar to those at Times t1 to t2 and Times t6 to t9 in FIG. 6, and details therefor are not repeated here for brevity. At Time t3, the display panel 102 starts updating the first row of the entire area, and the pulse of the backlight control signal BL starts. At Time t4, the active video frame VA1 starts. At Time t5, the display panel 102 has updated to 49% of the number of rows in the entire area, and the pulse of the backlight control signal BL ends. The interval between Time t3 and Time t5 is referred to as the ON time Ton of the pulse of the backlight control signal BL. At Time t6, the frame data B1 ends. At Time t7, the active video frame VA1 ends. At Time t8, the pulse of the backlight control signal BL starts again. The interval between Time t5 and Time t8 is referred to as the OFF time Toff of the pulse of the backlight control signal BL. At Time t9, the active video frame VA2 starts.

Since the pulse of the backlight control signal BL starts at the first row of the entire area and ends at ½ of the screen 20, the images in the portions A and C of the screen 20 are blurred and the image in the portion B is sharper, thereby reducing the motion blur.

While the optimal time for turning on the backlight in the embodiment is set at the period of updating the upper half of the screen, those skilled in the art may also set the time for turning on the backlight at the period of updating other areas of the screen as required according to the duty cycle of the backlight control signal BL, so as to sharpen the preset location.

The embodiments in FIGS. 1, 4, and 5 disclose a display device and a control method thereof automatically computing the starting time of turning on the backlight for various backlight duty cycles to obtain the optimal ON time of the backlight, sharpening the preset location of the screen, reducing motion blur for various backlight duty cycles, and increasing product functionality without increasing the manufacturing cost.

Those skilled in the art will readily observe that numerous modifications and alterations of the device and method may be made while retaining the teachings of the invention. Accordingly, the above disclosure should be construed as limited only by the metes and bounds of the appended claims.

1. A control method for use in a display device, the control method comprising:
obtaining a duty cycle of a backlight control signal of controlling a backlight source of the display device;
generating a threshold of the display device, wherein:
the threshold=((Vactive/4+Vfront)/(Vtotal/100));
Vactive is a quantity of rows in an active area of the display device;
Vfront is a quantity of rows in a vertical front porch of the display device; and
Vtotal is a quantity of rows in an entire area of the display device;
generating a starting time of a pulse in the backlight control signal, wherein:
the starting time=the threshold−((Y%*Vtotal−(Vactive/4))/(Vtotal/100)); and
Y % is the duty cycle; and
when the starting time exceeds the threshold, updating the starting time to the threshold.

2. (canceled)

3. The control method of claim 1, wherein at least a portion of an ON time of the pulse overlaps a duration when ¼ to ½ of an image is displayed on.

4-10. (canceled)

11. A display device comprising:
a backlight source; and
a controller coupled to the backlight source, and configured to obtain a duty cycle of a backlight control signal, generate a threshold of the display device, generate a starting time of a pulse in the backlight control signal, and update the starting time to the threshold when the starting time exceeds the threshold;
wherein the backlight control signal is used to control the backlight source;
the threshold=((Vactive/4+Vfront)/(Vtotal/100));
Vactive is a quantity of rows in an active area of the display device;
Vfront is a quantity of rows in a vertical front porch of the display device; and
Vtotal is a quantity of rows in an entire area of the display device;
the starting time=the threshold−((Y%*Vtotal−(Vactive/4))/Vtotal/100)); and
Y % is the duty cycle.

12. (canceled)

13. The display device of claim 11, wherein at least a portion of an ON time of the pulse overlaps a duration when ¼ to ½ of an image is displayed on the display device.

14-20. (canceled)
